(19) United States
(12) Patent Application Publication
(10) Pub. No.: US 2006/0282282 A1
(43) Pub. Date: Dec. 14, 2006

(54) Bonus tracking system and method

(76) Inventors: Brent A. Spechler, Hollywood, FL (US); Michael S. Bubley, Hollywood, FL (US)

Correspondence Address: LERNER GREENBERG STEMER LLP, P O BOX 2480, HOLLYWOOD, FL, 33022-2480, US

(21) Appl. No.: 11/445,493

(22) Filed: Jun. 1, 2006

Related U.S. Application Data
(60) Provisional application No. 60/687,410, filed on Jun. 3, 2005.

(51) Int. Cl. G06Q 99/00

(52) U.S. Cl. 705/1

(57) ABSTRACT

A bonus tracking system and method is provided wherein bonuses are tracked based on individuals referring other individuals to a service. Bonuses are paid based upon the services rendered by the referred individuals. Referring individuals are awarded a bonus based on individuals directly referred, as well as indirectly referred individuals.

### PRIORITY

The present application claims priority from co-pending U.S. provisional patent application serial No. 60/687,410, Filed on Jun. 3, 2005 and entitled BONUS TRACKING SYSTEM.

### BACKGROUND OF THE INVENTION

1. Field of the Invention

The invention relates to a bonus tracking system and methods of using the same. More particularly, bonuses are calculated based on services rendered by individuals directly and indirectly referred by an individual.

2. Description of the Related Art

Prior art systems use multi-level marketing programs to reward its sales people for products sold. There are no known multi-level marketing programs to reward individuals for referring other individuals for the provision of services.

What is needed is a multi-level system for providing bonus awards to individuals for recommending other individuals who provide a service.

### SUMMARY OF THE INVENTION

It is accordingly an object of the invention to provide a bonus tracking system and method is provided wherein bonuses are tracked based on individuals referring other individuals to a service. Bonuses are paid based upon the services rendered by the referred individuals. Referring individuals are awarded a bonus based on individuals directly referred, as well as indirectly referred individuals. In one particular embodiment, bonuses are calculated based on the hours worked/billed by a referred individual and the relationship of the referred individual to the original referring individual.

Other features which are considered as characteristic for the invention are set forth in the appended claims.

Although the invention is illustrated and described herein as embodied in a bonus tracking system and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is an illustration of referral tree or diagram useful for illustrating the operation of one method of the present invention.

FIG. 2 is a flow diagram of a simplified version of a method in accordance with one particular embodiment of the present invention.

FIG. 3 is a representative diagram of a system in accordance with one particular embodiment of the present invention.

FIG. 4 is a block diagram of the functional tables of a portion of a computerized bonus tracking system in accordance with one particular embodiment of the present invention.

FIG. 5 is one particular graphical user interface useful with a preferred embodiment of a bonus tracking system of the present invention.

FIG. 6 is a graphical representation of a referral tree diagram showing the relationships established by the actions taken in connection with FIG. 5.

FIG. 7 shows one particular format of a report detailing the bonuses calculated for the individuals of FIGS. 5 and 6, according to one particular method of the present invention.

### DESCRIPTION OF THE PREFERRED EMBODIMENTS

Referring now to figures, there is shown a bonus tracking system and method in accordance with one particular embodiment of the instant invention.

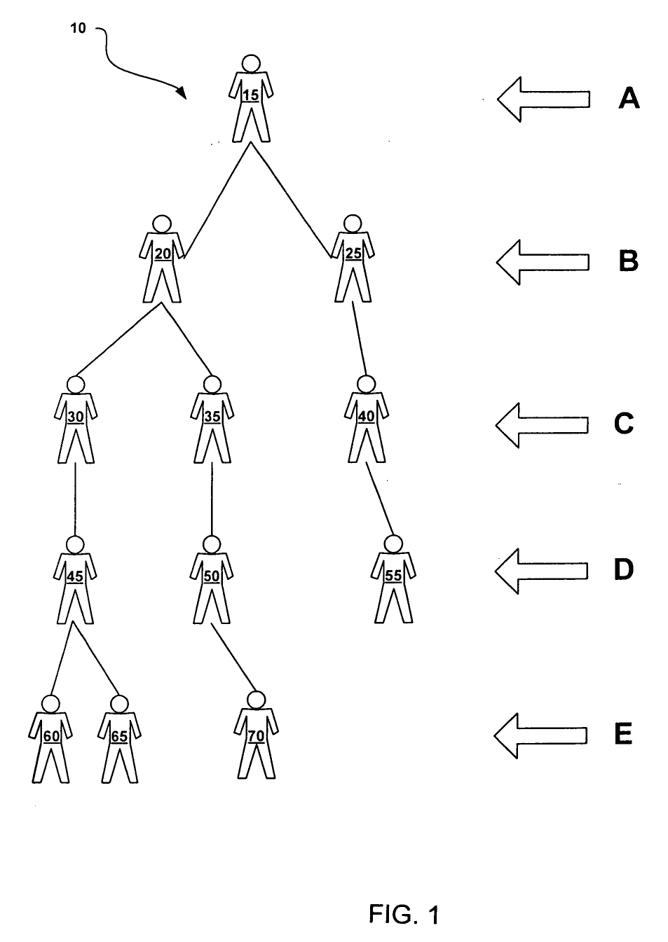

Referring now to FIGS. 1, there will be specifically described a method for calculating and paying bonuses to individuals (i.e., 15- 55) for personnel referrals, as shown in the referral diagram 10. In the method of the present embodiment, bonuses are aggregated to an individual based upon, not only the employees that an individual personally (i.e., “directly”) recruits, but additionally for employees recruited by recruits of the first individual, and so on. For example, FIG. 1 shows a first individual 15, who is in a first tier “A”. For purposes of example only, the tier “A” individual 15 is an original individual (i.e., individual, employee and/or independent contractor) that was not recruited by another individual in the method 10. Such an individual 35 will be referred to herein as a tier “A” individual. Note that, for purposes of explanation, the terms “individual”, “employee” and “contractor” will be used interchangeably herein.

In the method of the instant invention, when any individual directly recruits another individual, a recruitment bonus will be payable to the recruiter for services rendered by the recruited individual(s). In the present invention, the services rendered are those in the service industry. Bonuses are not paid, in the instant invention, for the sale of product or for time spent selling products. Rather, bonuses are based on services rendered, and most preferably, on work performed on a per-hour basis.

Applying this principle to the diagram 10 of FIG. 1, for example, when a tier “A” individual makes a referral of personnel, and that personnel is recruited into the system, the tier “A” individual 15 will receive a recruitment bonus for each individual “directly” recruited. In the example of FIG. 1, the tier “A” individual 15 directly recruits two individuals 20 and 25. These individuals 20 and 25 will be referred to as tier “B” individuals, as shown in FIG. 1. By means of illustration, in one particular example, individual 15 receives a bonus of $1.00 for each directly recruited individual. As such, individual 15 is paid $1.00 for the recruitment of individual 40 and $1.00 for the recruitment of individual 45, for a first tier bonus of $2.00. Note that the bonus amounts used to illustrate the instant example are not meant to be limiting, as bonus payments can be set at any desired amount and/or in accordance with customary practice and/or the going rate for referrals.

However, contrary to the operation of prior art referral and/or recruitment bonus systems, the bonuses to the individual 15 in tier “A” do not stop with the payments made for the direct recruitment of individuals 20 and 25. In accordance with the instant invention, individuals receive bonus credit, not only for individuals directly recruited, but additionally for individuals that are indirectly recruited. More particularly, an indirectly recruited individual is an individual who was recruited as a result of a direct recruitment made by another individual.

In the example of FIG. 1, if the individual 20 recruits the tier “C” individuals 30 and 35, then the individual 20 is said to have “directly” recruited the individuals 30 and 35 (i.e., and thus receive the direct recruiting bonus of $1.00 per employee, for a total of $2.00), while the individual 15 is said to have “indirectly” recruited the individuals 30 and 35, as a result of individual 15's direct recruitment of individual 20. Similarly, individual 15 is indirectly responsible for the recruitment of individual 40, through individual 15's direct recruitment of individual 25.

As stated above, under the method of the instant invention, an individual 15 is rewarded for the individuals 20 and 25 that individual 15 directly recruited, as well as for the individuals 30, 35 and 40 that the individual 15 indirectly recruited. However, under the currently described method of the preferred embodiment, an individual is rewarded a lesser amount or percentage for individuals indirectly recruited, than for individuals who are directly recruited. For example, in one particular illustration of the embodiment of FIG. 1, since the individuals 30, 35 and 40 of tier “C” are one generation removed from the individual 15, the individual 15 would be entitled to a lesser amount of payment for their recruitment. In one particular example, individual 15 would receive only fifty cents per individual directly recruited by the individuals 20 and 25 of tier “B”. As such, under this particular illustration, for the recruitment of individuals 30, 35 and 40, individual 15 is paid $1.50, while individual 20 gets $2.00 (i.e., for directly recruiting individuals 30 and 35) and individual 25 gets $1.00 (i.e., for directly recruiting individual 40). Again, the particular sums paid as bonuses are used for illustration purposes, only, and are not meant to be limiting.

In one particularly preferred embodiment of the instant invention, the bonus due for indirectly recruited individuals is further reduced based relative to the distance in relationship from the recruiter and the recruit (i.e., the number of tiers between them). For example, in FIG. 1, if the individuals 30, 35 and 40 directly recruit the tier “D”individuals 45, 50 and 55, as shown, the individual 15 gets a further reduced bonus for having indirectly recruited individuals in tier “D”. For example, in the particular illustration used above, the individuals 30, 35 and 40 would each receive $1.00 for having directly recruited the individuals 45, 50 and 55, respectively, while the individual 20 would receive $1.00 for indirectly recruiting individuals 45 and 50 (i.e., fifty cents each) and individual 15 would receive twenty-five cents for each tier “D” individual (45, 50 and 55) indirectly recruited.

In the present particular embodiment, the further the tier from the original recruiter, the more the bonus paid to the original recruiter is reduced. For example, individual 15 may only receive a fraction of the bonus for indirectly recruiting tier “E” individuals than was received for indirectly recruiting tier “D” or tier “C” individuals. The same would be true for the bonus due to individuals in any tier, relative to subsequent tiers.

Table 1, below, illustrates the bonus earned by each of the individuals 15-70 using the method of the instant invention in connection with the particular example of FIG. 1, wherein direct recruiting earns a bonus of $1.00, first tier indirect recruiting earns a bonus of fifty cents, second tier indirect recruiting earns a bonus of twenty-five cents and third tier indirect recruiting earns a bonus of ten cents.

TABLE 1

| | | Bonus for | Bonus for | Bonus for | Bonus for | |
|---|---|---|---|---|---|---|
| | Ind | Tier B | Tier C | Tier D | Tier E | |
| Tier | # | (Ind. #s) | (Ind. #s) | (Ind. #s) | (Ind. #s) | Total |
| A | 15 | $2.00 | $1.50 | $0.75 | $0.30 | $4.55 |
| | | (15, 20) | (30, 35, 40) | (45, 50, 55) | (60, 65, 70) | |
| B | 20 | n.a. | $2.00 | $1.00 | $0.75 | $3.75 |
| | | | (30, 35) | (45, 50) | (60, 65) | |
| | 25 | n.a. | $1.00 | $0.50 | $0.00 | $1.50 |
| | | | (40) | (55) | | |
| C | 30 | n.a. | n.a. | $1.00 | $1.00 | $2.00 |
| | | | | (45) | (60, 65) | |
| | 35 | n.a. | n.a. | $1.00 | $0.50 | $1.50 |
| | | | | (50) | (70) | |
| | 40 | n.a. | n.a. | $1.00 | $0.00 | $1.00 |
| | | | | (55) | | |
| D | 45 | n.a. | n.a. | n.a. | $2.00 | $2.00 |
| | | | | | (60, 65) | |
| | 50 | n.a. | n.a. | n.a. | $1.00 | $1.00 |
| | | | | | (70) | |
| | 55 | n.a. | n.a. | n.a. | $0.00 | $0.00 |
| E | 60 | n.a. | n.a. | n.a. | n.a. | $0.00 |
| | 65 | n.a. | n.a. | n.a. | n.a. | $0.00 |
| | 70 | n.a. | n.a. | n.a. | n.a. | $0.00 |

In summary, the method of the instant invention rewards personnel for recruiting individuals, by awarding a bonus, not just for directly recruited individuals, but also for indirectly recruited individuals. The amount of such bonus can be based upon the remoteness from the original recruiter, such that the more remote the individual from the original recruiter, the lesser the bonus amount.

Additionally, it can be appreciated that such bonus may be a one-time bonus paid out as each subsequent person is recruited. However, in one particular embodiment of the method of the instant invention, the bonus is preferably structured as an on-going payment based on the hours worked by an employee. Note that, the on-going payment could be based on some other measure of services rendered, for example, hours billed, or placement fees paid. Additionally, the fees could be paid as a percentage of gross billings.

For example, one intended area of use for the instant method is in an employment agency. In such an employment agency, the agency takes a percentage of the wages paid to an employee placed by the agency. Such percentage can be based on the per hour wage paid to the employee. The method of the instant invention can be used to facilitate the recruitment of further qualified personnel to the employment agency. More particularly, a portion of the percentage paid to the agency for a placement can be used to reward the recruiters (i.e,. direct and indirect recruiters) of that employee. As such, a percentage of the hourly wages paid to an employment agency for the placement of an employee can be paid as an on-going royalty-like stream to all of the employees responsible for bringing in the employee. The guarantee of such on-going payment stream can ensure that the very best people are attracted to the agency, and that they are motivated to recommend it to their colleagues. As can be seen, the money paid as bonuses is not based on the work done by the recruiting employee, but is based on the amount of work done by the recruited employee, and the degree or relationship between the recruiting employee and the recruited employee (i.e., direct recruitment vs. some tier of indirect recruitment).

The method described in connection with the instant invention is particularly useful in the area of nursing, wherein nurses are provided by an agency to a hospital, hospice, organization or individual, on an as needed basis, and the agency is paid a “placement” fee for such placement. The recruiting of other types of skilled labor (i.e., carpenters, plumbers, teachers, electricians, etc.) could additionally be facilitated using the method described herein. As such, in times of shortage of trained personnel in certain fields, the instant invention can be used to motivate skilled workers to register with a particular employment agency and to recommend it to their similarly skilled colleagues. As such, the instant invention calculates a bonus for individuals based on services rendered, and not based on products sold.

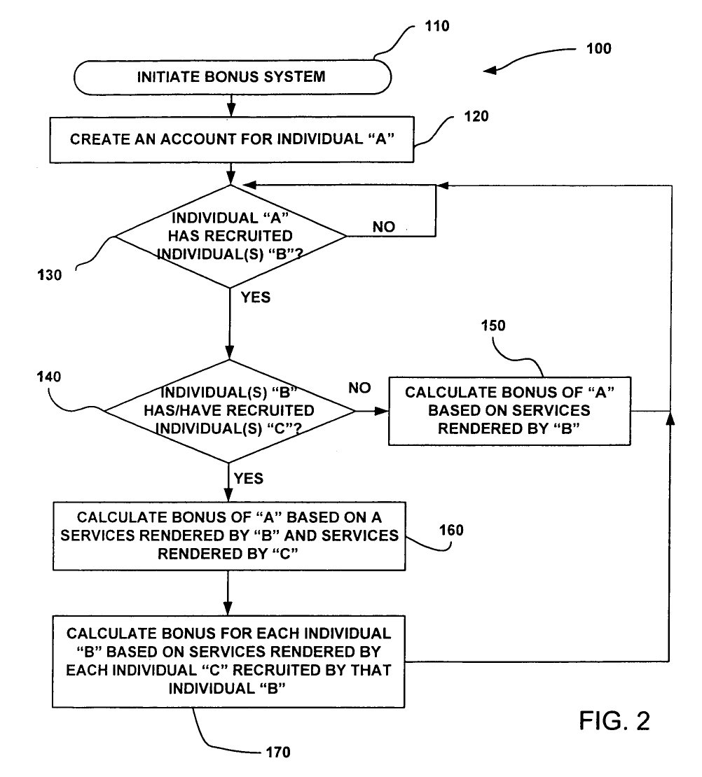

Referring now to FIG. 2, there is shown a simplified form of a method 100 in accordance with one particular embodiment of the instant invention. In the method 100, a bonus system is initiated. Step 110.

An account must be started for each individual that takes part in the bonus system. If an individual was referred by another individual, an account is created, wherein the second individual's account is linked to the first individual's account for bonus tracking purposes. However, if the first individual was not referred by another person in the system, an account is created for that individual “A” that is not yet linked to any other account for bonus purposes. Step 120.

In accordance with one particular preferred embodiment, if an individual “A” does not recruit any other individual, the individual “A” does not receive a bonus for recruiting activities. Step 130. However, if the individual “A” has recruited at least one individual “B”, it is possible that the individual “A” will receive a bonus for the recruitment of the individual(s) “B”. Step 130. The payment of a bonus to individual “A” for the recruitment of individual(s) “B”can be based on a number of factors. First, as described above, individual “A” can receive a one-time fee for the recruitment of the individual(s) “B”. Alternative to, or in addition to, a one-time fee, the individual “A” can receive an on-going royalty-like stream based on the services rendered by individual(s) “B”. For example, the individual “A” can earn as a bonus, a flat fee on every hour billed by each of the individual(s) “B” (i.e., the dollar in the example of FIG. 1) or even a percentage of the hourly wage earned by the individual(s) “B”, as well as or instead of, a lump sum finder's fee. In the embodiment of FIG. 2, the individual “A” receives an on-going royalty stream based on the services rendered and, correspondingly, the wages earned by the individuals “B”. As such, if the individual(s) “B”do/does not render any services, and the service earns no fees from the individual(s) “B”, the individual “A” does not receive any bonus based on services rendered by the recruited individual(s) B.

If the individual(s) “B” have rendered services, and thus brought in a wage from which a bonus can be paid, in calculating the bonus to individual “A”, it is important to determine whether any of the individual(s) “B” have additionally recruited any further individuals. Step 140. If the individual(s) “B” has/have not recruited further individuals, the bonus for individual “A” is calculated based on the services rendered by “B”, if any. Step 150. Note that such bonus can be calculated in any desired interval, such as weekly, monthly or yearly.

Additionally, as stated above, the bonus calculation for “A”can be either a set amount per hour worked (and thus wages earned/fees paid) by each individual “B” (i.e, $1.00 per hour, per individual “B”), or can be a percentage of the wages earned or fees paid by each individual “B” (i.e., 10% of the fees paid by each individual “B” to an employment or other bonus calculating service). However, if the individual(s) “B” has/have not recruited any further individuals, no bonus is calculated for or paid to the individual(s) “B”.

Once the individual(s) “B” has/have recruited individual(s) “C” (step 140), the individual(s) “B” become eligible for a recruitment bonus (i.e., instead of or in addition to any finder's fee paid to “B” for initially recruiting “C”). In accordance with the instant invention, any bonus calculated for “A” will include bonuses accrued as a result of services performed by the individual(s) “C”. As such, once the individual(s) “C” render services in the system, thus earning wages from which placement fees are paid, bonuses for the recruitment of “C” can be calculated. Since the recruitment of all individuals “C” are a result of the recruitment the individual(s) “B” by individual “A”, the bonus calculated for individual “A” will include a portion attributable to the services rendered by individual(s) “B”, if any, and a bonus portion calculated for services rendered by individual(s) “C”, if any. Step 170. Note that, if desired, the rate paid to “A” for a bonus on the services of “B” can be the same rate paid for a bonus on the service of “C”. However, in the most preferred embodiment, a greater rate of bonus is paid for directly recruiting individuals, than is paid for indirectly recruiting individuals.

As such, under the most preferred embodiment of the invention the sum paid to “A” for direct recruitment individual(s) “B”is greater than the sum paid to “A” for the indirect recruitment of individual(s) “C”. As described above, the bonus can be calculated as a flat rate for each hour worked by “B” and “C”, or, if desired, a percentage of the fees paid by “B” and “C” for their wage-earning placement. For example, as described above in connection with FIG. 1, in one particular illustration of the invention, an individual “A”would accrue a bonus based on a flat rate of $1.00 for each hour worked by each individual “B” and $0.50 for each hour worked by each individual “C”. However, a percentage, of the placement fee can be paid to “A” as a bonus, such as 10% per hour (or 10% of the total placement fee paid) for services rendered by “B” and 5% for services rendered by “C”.

Additionally, the particular individual(s) “B” that directly recruited each individual “C” would accrue a bonus based on services performed by those individual(s) “C”, and such bonus will be calculated. Step 170. Note that in the instant example, although the individual “A” will accrue a bonus based on services rendered by every individual “C”, an individual “B” will only accrue a bonus based on services rendered by individual(s) “C” directly recruited by that particular individual “B”.

Bonuses continue to be calculated under the method 100, so long as individuals continue to render billable services. The method illustrated in FIG. 2 is a simplified illustration of the method of the instant invention. Note that only three generations are illustrated (i.e., individuals “A”, “B” and “C”), in reality, an unlimited number of tiers can branch off from individual “A” (i.e., “A”, “B”, “C”. . . n). Additionally, the invention can be adapted such that the bonus paid to an individual can be terminated when that individual leaves the system (i.e., quits a staffing agency). Alternatively, in the method of the instant invention, payment of a bonus can continue even after the recruiting individual leaves the system (i.e., a legacy bonus).

Additionally, the system and method of the present invention can include certain additional bonus controls and elements. For example, in one particular embodiment of the instant invention, a person who recruits a second individual may receive a bonus based on the amount billed by the second individual for a term of years, after which the bonus terminates. For example, a first individual who recruits a second individual may receive a bonus of $1.00 per hour billed by the second individual for a period of five years from the requirement of the second individual, after which, no further residuals are paid to the first individual for work performed by the second individual. Additionally, if the second individual recruits a third individual, and the first individual receives a bonus for work billed by the third individual, that bonus can additionally terminate when the bonus for the second individual terminates (i.e., five years). Alternatively, the bonus due to the first individual for the indirect recruitment of the third individual may be chosen to terminate a term of years (i.e., five years) from the date the third individual was recruited by the second individual, or otherwise as desired.

The system and method of the instant invention can further be set up to award milestone bonuses when certain levels have been achieved.

In one particular example, when the number of hours that are billed by individuals recruited by a first individual reaches a pre-defined level, the first individual may receive a one-time bonus in addition to the on-going bonuses awarded based on hours billed. For example, if the accumulated hours of individuals recruited by a first individual totals 10,000 hours, the first individual may receive a further one-time bonus/payment of, for example, $2,500.00.

Other types of milestone bonuses may additionally be awarded. For example, the preset rate awarded to an individual for each hour billed by recruited individuals can be increased at certain milestones. In one particular embodiment, the preset flat fee of $1.00 per hour billed by individuals directly recruited by a first individual can be raised to $1.50 per hour billed by those individuals once 10,000 hours is reached. The preset flat fees per hour billed for indirectly recruited individuals could also be proportionally raised.

Further, at particular milestones, the residual term can be increased as a milestone bonus. For example, once individuals recruited by a first individual exceeds a certain milestone, for example, 25,000 hours, the term in which the bonus is paid can be extended, for example, from five years to six years.

If desired, more than one milestone bonus can be employed. In one particular embodiment of the instant invention, individuals are rewarded with flat fee bonuses, increased preset flat rates per hour billed and extended residual terms, all at particular milestones. Table 2 shows the different milestone bonuses and residuals for one particular embodiment of the instant invention.

TABLE 2

| Hours Billed By | Fee Per Hour | | |
|---|---|---|---|
| Referred | (Direct | | Residual |
| Individuals | Referrals) | Flat Fee Bonus | (Years) |
| 1-10,000 | $1.00 | $2,500 @ 10,000 hrs | 5 |
| 10,001-15,000 | $1.50 | | 5 |
| 15,001-20,000 | $2.00 | $5,000 @ 20,000 hrs | 5 |
| 20,001-25,000 | $2.50 | | 6 |
| 25,001-30,000 | $3.00 | $10,000 @ 30,000 hrs | 6 |
| 30,001-35,000 | $3.50 | | 7 |
| 35,001-40,000 | $4.00 | $20,000 @ 40,000 hrs | 8 |
| 40,000+ | $5.00 | | 8 |
| 50,000+ | | | Lifetime |

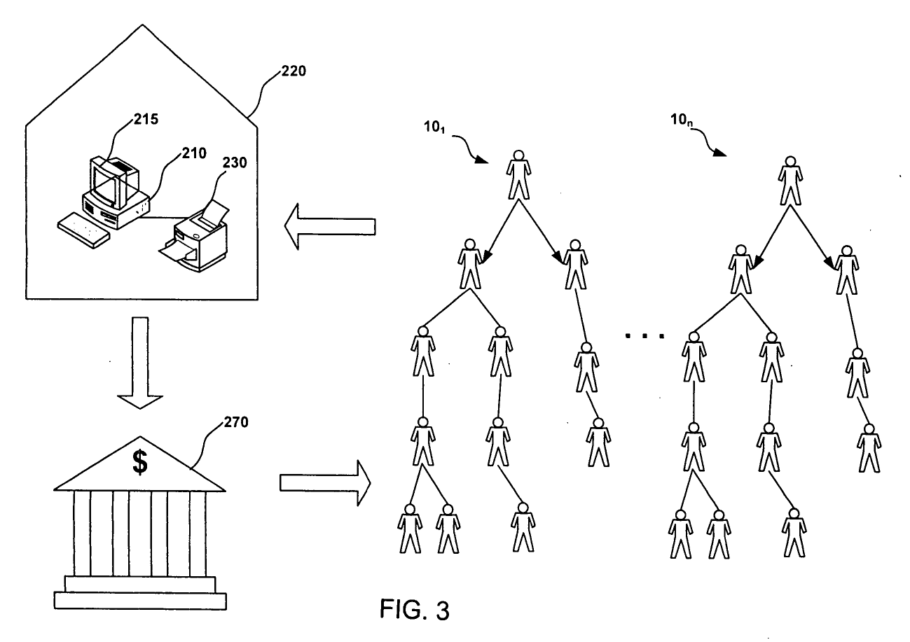

Referring now to FIG. 3, there is shown a system 200 for tracking, calculating and paying a bonus, in accordance with one particular embodiment of the present invention. More particularly, the system 200 can be used to calculate bonuses for referrals made from individuals arranged in multiple referral trees, such as the referral tree 10₁-10ₙ of FIG. 3.

More particularly, the system 200 includes the necessary software for tracking job assignments of employees, assign bonus amounts to be paid for referrals, and calculate the bonus amount to be paid to employees. Such software may be located on a computer 210 in a central location, or may be distributed throughout a network of computers located at various locations. Additionally, a computer containing the software, such as computer 210, can be located at a first location 220, while a database containing all of the stored employee data can be located at a separate location that is remotely accessed by the computer 210, as well as by other computers (not shown) at other locations which participate in the method of the invention.

The bonus tracking software of the system 200 will be used to populate a database including detailed information about clients (employers), employees (both in-house and contract), assignments, work hours and administrative items, such as the number of employee related tier levels and the reward level for each tier level. As described above, in one preferred embodiment of the method of the instant invention, the system 200 will track referrals made by employees, for other employees, and calculate the referral bonus based on the number of hours worked by each referred employee and the level of relatedness to or “tier” of each referring employee (i.e., whether a direct referral or some level of indirect referral).

The number of “tiers” for which the system will calculate a bonus will be variable, thus allowing the system administrator to change the number of rewarded tiers. For example, in one particular embodiment of the present invention, the system 200 will reward an employee for a referral in the fifth tier. Using the example of FIG. 1, such a system will only reward the first tier “A” individual 15 for the referral of employees in the fifth tier “E”. Note, however, that each employee under such a system would be entitled to a bonus on their own relative fifth tier referrals, such that, if the individuals 60, 65 or 70 make a referral, the individual 15 of the first tier “A” would not get a bonus, but the original referring individual in the second tier “B” would still get a bonus for the referral of any tier “F” employees. Following that example, fifth tier “E” individuals 60, 65 and 70 would receive a bonus down to the related ninth tier “I” employees (not shown in FIG. 1), who would be fifth tier relative employees to the individuals in tier “E” (i.e., tier “E” being the first tier for individuals 60, 65 and 70). Note however, in awarding a bonus, any number of tiers relative to a referring party can be chosen in the system 200, as desired.

In creating the software for the system 200 and its associated database, the system 200 need not duplicate any personnel or payroll functions (such as tax withholdings) of existing systems. Rather, the software for the system 200 is designed to operate alongside and/or be integrated with existing personnel and payroll systems utilized for managing employees and clients. Alternatively, the software for the bonus tracking system 200 can operate independently from any other personnel or payroll software, if desired.

The software of the system 200 can be made using the standard MICROSOFT WINDOWS™ operating system format, thus ensuring that each screen has the same look and feel, throughout the system. This is not meant to be limiting, as it can be seen from the description herein how the software for tracking the bonus method of the instant invention can be adapted for use on another platform, such as LINUX™ and/or APPLE MACINTOSH™.

The software of system 200 will preferably include a graphical user interface to increase the ease of interaction between the individuals populating the database (i.e., entering data) and the software. For example, the software of the system 200 can use title bars, menu bars, drop down menus and virtual buttons to facilitate data entry. For example, each screen of the user interface between the data entry individual and the software can be tilted on a “title bar” so that the location in the data entry process is readily identifiable.

Additionally, in one preferred embodiment of the instant invention, the database can be constructed to include, among other things:
a “data dictionary” including descriptions of tables, relationships, etc.;
a relationship will exist for all related items, thus eliminating most of the redundancy of data; and
a security system or protocol to limit access to data only to authorized individuals.

Additionally, when the software is accessible through a network, as described above, the number of users accessing the software is preferably only limited by the network resources, and not by the software. Alternatively, the software, itself, may be set to limit the number of accessing individuals, if desired.

It is important to note that the calculation of a bonus in the system 200 and in accordance with the method of the invention is not merely the operation of an algorithm. Rather, the system 200 produces useful, concrete and tangible results using inputs received from outside the computer system. The computer 210 includes a monitor 215, upon which bonus calculations can be displayed. Additionally, a printer 230 attached to the computer 210, or in communication with a network of which computer 210 is a part, can be used to print bonus reports, and/or to print bonus checks that can be distributed in the individuals in the referral trees 10₁-10ₙ. Further, reports and/or underlying information and data (i.e., electronically or in paper form) can, optionally, be forwarded to a remote financial and/or payroll institution 250, wherein the calculated bonuses can be converted into bonus payments to the referring individuals. For example, such bonus information and/or bonus reports can be used by the institution 250 to issue payroll and/or bonus checks to the recipient individuals in the referral trees 10₁-10ₙ. Additionally, the information and/or bonus reports can be used by the institution 250 to electronically issue a credit to the recipient individuals in the referral trees 10₁-10ₙ.

As such, in the system 200, bonuses calculated in accordance with the methods of the present invention are converted into, and outputted as, actual bonus payments to the recipient individuals.

The reporting capabilities of the system 200 can be maintained on a real-time basis. As such, the printer 230 can be used to print bonus reports, including reports of bonuses accrued. Such reports can be grouped by individual, by relationship, by office, or by any other desired criteria.

Further, the software used in the system 200 of the instant invention can be used to maintain and provide employee management and client statistical data on a real-time basis.

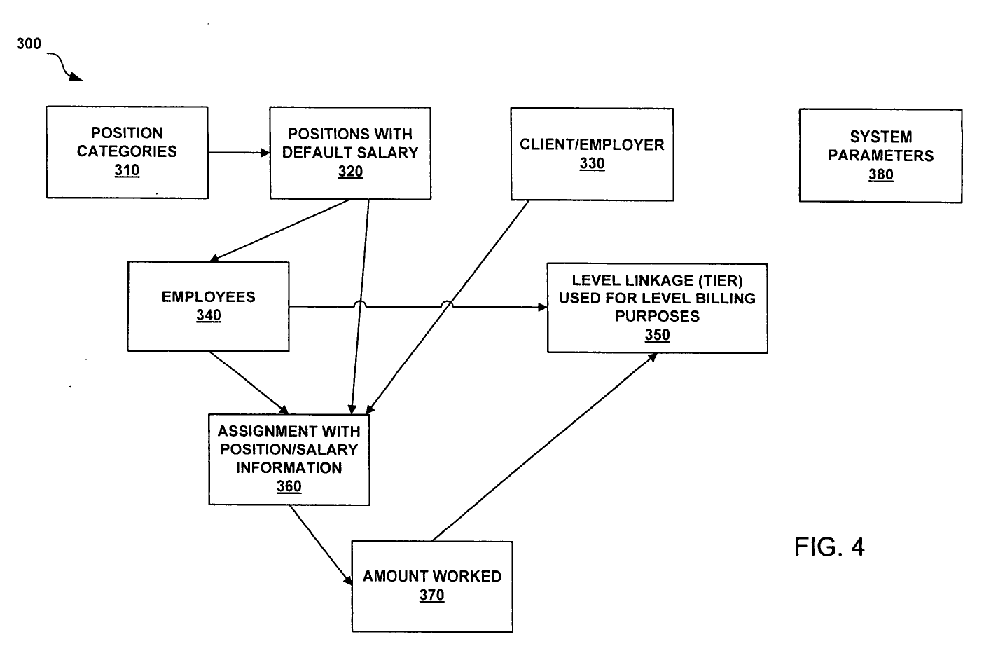

Referring now to FIG. 4, there is shown a block diagram of the functional tables of a portion of the software system 300 for a computerized bonus tracking system, such as was described in connection with the bonus system 200 of FIG. 3. More particularly, the system of FIG. 4 allows for the entry of information to be linked in related tables. Preferably, each of the tables shown in FIG. 4 will be updated to include (and thus, to report) all additions, modifications and deletions to the database records.

The system 300 will allow for importing of data (in a predetermined format) into various tables of the system database. Such tables that are populated using the software 300 include the position categories table 310, the position/salary table 320, the client/employer table 330 and the employees table 340. Additionally, the system 300 will track the various “tier” levels used to relate the individuals when one individual refers another individual into the system and the referred individual provides bonus-earning services. Such “tiers” may be established and maintained in the level linkage table 350, while the assignment information of, and amount worked by, the referred individual is maintained in the assignment table 360 and the amount worked table 370, which are linked back the related individual(s). Note that, as described above, in the most preferred embodiment, an individual earns a bonus per-hour-worked by a referred individual, and based on the level linkage (i.e., tier) value of the referred individual to the bonus earning referrer. As such, as can be seen, the assignment table 360 and the amount worked table 370 are linked to the level linkage table 350, for the purpose of calculating particular bonus amounts. In the preferred system, the bonus amounts can be calculated at any time, as the system enters updates the information in real-time. System parameters, such as the maximum rewarded relative tier number, and the tier bonus amounts, are stored in the system parameters table 380.

The system 300 may be implemented in any desired way. In one particular embodiment, the system 300 is implemented and programmed using VISUAL FOXPRO™ 6.0. In such an embodiment, the standard modules of VISUAL FOXPRO™ are used, in addition to any add-on software libraries that are developed by the developer of system 300. As such, the system 300 will be entirely self-contained, thus eliminating the need for the FOXPRO™ DEVELOPMENT SYSTEM. However, if desired, the FOXPRO™ DEVELOPMENT SYSTEM may be used to further develop the system 300 and/or for trouble-shooting the system 300.

Additionally, if desired, to enhance the security of the data, the system 300 can limit access to the tables contained therein. For example, core database tables, such as the client/employer table 330,the employees table 340, the assignments table 360 and the amount worked table 370, can be set as core levels that are accessible throughout the system 300 (i.e., providing access to all levels of users). Such support database tables as the position categories table 310, the position/salary table 320, the level linkage table 350 and the system parameters table 380 can be defined to limit access to particular individuals of the system 300.

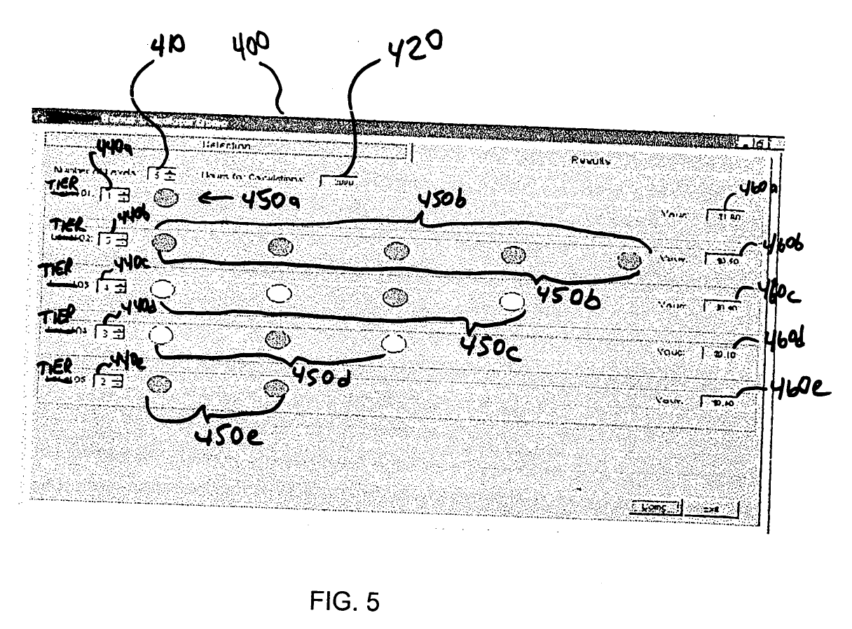

Referring now to FIG. 5, there is shown one example of the graphical user interface for a particular module of a preferred embodiment of a bonus tracking system in accordance with the present invention. More particularly, FIG. 5 shows an interactive user interface screen display 400 for a bonus calculator module of a bonus tracking system. The bonus calculator module can be used to instantaneously project the bonus amounts to be paid to individuals. Such a bonus calculator can be used to calculate the bonus of as few as 1 individual, or an unlimited number of individuals (i.e., only restricted by the computer system limitations). When starting the bonus calculator, the screen 400 will, prompting the data entry user to select the number of levels for which an individual can be rewarded. In one particular embodiment described above, the maximum relative tiers permissible for rewarding an individual is chosen to be five tiers, but more or fewer may be chosen. The screen 400 permits the number of levels or “tiers” to be selected at 410.

Additionally, the number of hours to be used for calculation of the bonus (i.e. the number of hours worked by an individual) is entered at 420.

The bonus calculator module permits the amount of a bonus awarded for each tier level to be set at 430. Using a clickable button interface, the number of individuals added to each tier, and to whom they are related can be selected at 440a-e and 450a-e, respectively. Additionally, the rate at which individuals of each tier of relatedness are rewarded is selectable at 460a-e. In order to relate a subsequent individual to a previous one using the buttons 450a-e, in the instant embodiment illustrated in FIG. 5, as the number of individuals is selected, the button or empty circle is darkened on the related level line. Selections can be changed simply by unselecting the button.

In the example of FIG. 5, for the purposes of projecting a bonus for an individual, the following number of employees have been generated by the original referrer in tier one.

TABLE 32

| Tier | # of Individuals |
|---|---|
| 1 | 1 |
| 2 | 5 |
| 3 | 20 |
| 4 | 15 |
| 5 | 10 |

The individuals of Table 3 are calculated as follows. Tier one represents the original first tier individual, of which there is only one. In the example of FIG. 5, the first tier individual directly generated five additional individuals (i.e., “tier two”) as shown in box 440b. Since these individuals are all linked to the sole first tier individual, the button 450a representing the sole individual is darkened. The tier one individual receives a bonus, as shown in box 460a, of $1.00 per hour worked per individual in tier two.

Each of the five second tier individuals directly generated four individuals (i.e., “tier three”), as shown in box 440c (5“tier two” individuals×4 “tier three” individuals=20 individuals in “tier three”). As all five “tier two”individuals generated generated four individual each, all five circles 450b are darkened, to indicate a linkage to all of the tier two individuals. The tier one individual receives a bonus, as shown in box 460b, of $0.50, while the tier two employees receive $1.00 per hour worked per individual in tier three.

However, as shown in FIG. 5, only the individual #3 of each of the five tier three groups generated any new individuals. These five employees #3 each generated 3 individuals, as shown in box 440d (5“tier three” individuals×3“tier four”individuals=15 individuals in “tier four”). To show that only the third individual of every “tier three” group recruited individuals, the other employees buttons 450c are turned to white, showing the linkage only with the tier three individuals by the third circle being darkened. Per box 460c, the tier one individual receives a bonus of $0.40, while the tier two individuals receive $0.50, and the tier three individuals receive $1.00 per hour worked per individual in tier four.

Further, as shown in FIG. 5, each individual #2 of tier four generates two additional individuals, as shown in box 440e (5 “tier four” individuals×2“tier five” individuals=10 individuals). Again, that the second individuals of each tier four group are the only ones that generated these individuals are indicated y the darkened and white circles in area 450d. Per box 460d, the tier one individual receives a bonus of $0.10 per hour, while the tier two individuals receive $0.40 per hour, the tier three individuals receive $0.50 per hour, and the tier four individuals receive $1.00 per hour worked per individual in tier four. Note that, since the number of rewarded tiers are limited to five tiers in the present embodiment, if the tier five individuals recruit additional individuals, the first tier individual does not receive further compensation, as shown in box 460e.

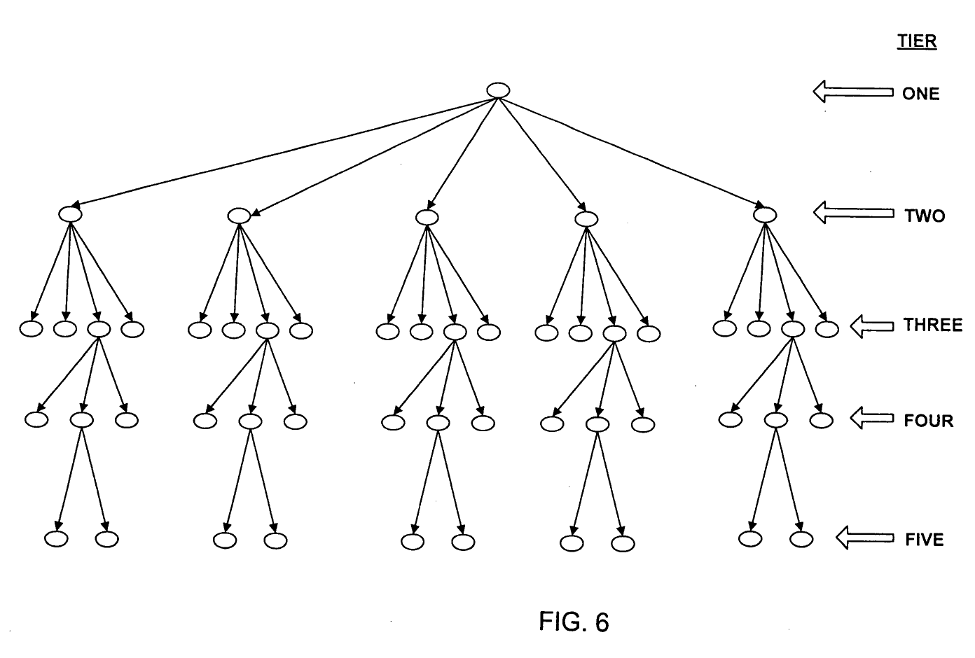

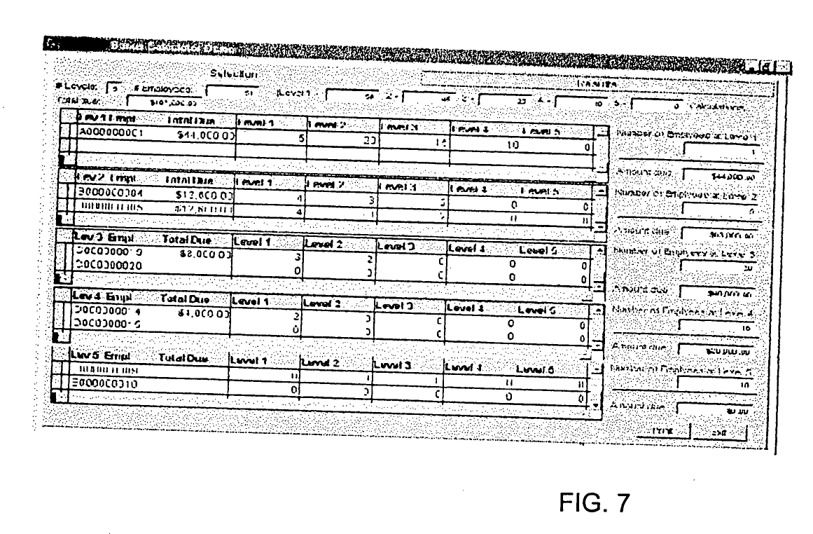

A referral tree diagram graphically showing the relationships established by the actions taken on the screen 400 of FIG. 5 is shown in FIG. 6. Additionally, there is shown in FIG. 7, a report detailing the bonuses calculated for the individuals of FIGS. 5 and 6, according to the methods described herein.

Note that the report of FIG. 7 can be displayed on a monitor and/or printed. Additionally, the report of FIG. 7 and/or the data therein can be forwarded to a financial or payroll institution, as described in connection with FIG. 3.

Note that the method of the instant invention can additionally be used in system where records are kept manually, without the assistance of a computer.

One particular application for the system and method of the instant invention is in connection with a staffing company that provides any type of occupation to client companies on a temporary or long-term contract basis. In one embodiment, a staffing company would use the system and/or method of the invention to recruit and retain employees, including “hard-to-find” employees. In one particularly preferred embodiment, employees would be rewarded via a networking system on a per employee, per hour basis.

In contrast to a multilevel marketing program that rewards sales people based on the sale of products, the staffing company would reward its employees who make referrals for services. For example, an “upline” individual, employee or independent contract who makes referrals to the staffing company, but who does not work as an hourly employee for the staffing company, can still be paid for referrals made to the staffing company. In one particular embodiment of the invention, an individual making referrals to the staffing company will be paid a bonus for the services of directly referred and indirectly referred employees, as many as five tiers remote from the original referring individual. Note that, however, this need not be limiting, as an individual can receive a bonus for indirectly referring individuals any number of tiers removed from the original referring individual. As stated above, in one particularly preferred embodiment, the payment to the referring individual would be based on the hours worked by the referred employee(s) during a set time frame (i.e., calculated daily, weekly, monthly, yearly, etc.). Such referred employee(s) are any employee(s) in a particular individual's “downline” (i.e., any directly or indirectly referred employee downstream of the referring individual).

Additionally, in the presently preferred embodiment of a staffing company, the nearer the relationship to the original individual, the higher the paid commission or bonus. Note however, this will still be financially rewarding to an individual making an original referral because, although the downline commissions decrease per hour, the number of downline employees should increase through added indirect referrals.

Among the advantages existing for using the system and/or method of the present invention, include:
drastically decreasing employee advertising dollars, which are a major expense to staffing companies;
providing for exceptional retention of employees, which reduces training costs;
providing for an automatic peer-to-peer employee quality control program, maintaining on-time performance, quality work, good work ethics and all the exceptional qualities an employer would expect from their own employees;
maintaining an extremely high retention rate of employers, due to their high satisfaction of services; and
generating exceptional gross billings of clients, due to the provision by the staffing agency of quality services from an abundant supply of “hard-to-find” personnel.

We claim:

1. A method for awarding a bonus, comprising the steps of:
storing information of a first individual;
associating information relating to at least a second individual referred by the first individual with the stored information of the first individual;
calculating at least a first portion of a bonus for the first individual based on an amount of services rendered by the at least a second individual.

2. The method of claim 1, wherein the at least a first portion is calculated based on the number of hours of services rendered by the at least a second individual.

3. The method of claim 2, wherein the at least a first portion is calculated as a preset flat fee for each hour billed by the at least a second individual.

4. The method of claim 1, wherein the at least a first portion is a percentage of the gross billings for services rendered by the at least a second individual.

5. The method of claim 1, wherein the bonus calculated for the first individual further includes a second portion not based on the amount worked by the at least a second individual.

6. The method of claim 1, wherein the second portion includes a finder's fee.

7. The method of claim 1, wherein the at least a second individual is directly referred by the first individual.

8. The method of claim 1, wherein the at least a second individual is indirectly referred by the first individual.

9. The method of claim 1, further including the steps of:
associating information relating to at least a third individual referred by the at least a second individual with the stored information of the first individual;
calculating at least a second portion of a bonus for the first individual based on an amount of services rendered by the at least a third individual; and
adding the at least a first portion and the at least a second portion to determine a bonus for the first individual.

10. The method of claim 9, wherein the at least a first portion is calculated as a first preset flat fee for each hour billed by the at least a second individual and the at least a second portion is calculated as a second preset flat fee for each hour billed by the at least a third individual.

11. The method of claim 10, wherein the first preset flat fee is greater than the second preset flat fee.

12. The method of claim 9, further including the step of:
calculating at least a first portion of a bonus for the at least a second individual who referred the at least a third individual based on an amount of services rendered by the at least a third individual.

13. The method of claim 12, wherein the at least a first portion of a bonus for the first individual is calculated as a first preset flat fee for each hour billed by the at least a second individual and the at least a second portion of a bonus for the first individual is calculated as a second preset flat fee for each hour billed by the at least a third individual and the at least a first portion of a bonus for the at least a second individual is calculated as a second preset flat fee for each hour billed by the at least a third individual.

14. The method of claim 13, wherein the first preset flat fee and the third preset flat fee are the same.

15. A method for calculating a bonus, comprising the steps of:
recruiting at least a first individual by a second individual;
recruiting at least a third individual by the first individual; and
calculating a bonus for the second individual based on the hours billed by the first individual and the hours billed by the third individual.

16. The method of claim 15, further including the step of:
calculating a bonus for the first individual based on the hours billed by the third individual.

17. The method of claim 16, wherein the step of calculating the bonus for first individual includes calculating the bonus at a first rate per hour billed by the first individual and at a second rate per hour billed by the third individual, wherein the first rate and the second rate are different.

18. A system for calculating a bonus, comprising:
a user interface for entering information of a first individual, including information relating to individuals referred by said first individual and an amount of services performed by each individual referred by said first individual;
a storage medium for storing said information of said first individual, said information of said individuals referred by said first individual, and said amount of services performed by each individual referred by said first individual;
a processor for calculating the bonus due to said first individual based on said amount of services performed by each individual referred by said first individual; and
an output device for outputting the bonus calculated by said processor.

19. The system of claim 18, wherein the bonus is calculated on a preset rate per hour billed by each individual referred by said first individual.

20. The system of claim 19, wherein the preset rate is higher for individuals directly referred by said first individual then for individuals indirectly referred by said first individual.
